(19) United States
(12) Patent Application Publication
(10) Pub. No.: US 2019/0196867 A1
(43) Pub. Date: Jun. 27, 2019

(54) SYSTEM AND METHOD OF PRIORITY-BASED INTERRUPT STEERING

(71) Applicant: QUALCOMM Incorporated, San Diego, CA (US)

(72) Inventors: Erich Plondke, Austin, TX (US); Suresh Kumar Venkumahanti, Austin, TX (US); Lin Wang, Pullman, WA (US); Lucian Codrescu, Austin, TX (US)

(21) Appl. No.: 15/983,992

(22) Filed: May 18, 2018

Related U.S. Application Data
(60) Provisional application No. 62/609,113, filed on Dec. 21, 2017.

(51) Int. Cl. G06F 9/48

(52) U.S. Cl. CPC G06F 9/4818; G06F 9/4881

(57) ABSTRACT

A processor includes priority adjustment circuitry configured to adjust a priority of a thread of multiple threads configured to execute tasks to have a software-defined priority value or a designated high priority value. The processor also includes circuitry configured to identify a lowest priority thread of the multiple threads and a control unit configured to cause the lowest priority thread to take a pending interrupt.

### I. CROSS REFERENCE TO RELATED APPLICATIONS

The present application claims the benefit of U.S. Provisional Patent Application No. 62/609,113, entitled “System and Method of Priority-Based Interrupt Steering,” filed Dec. 21, 2017, which is expressly incorporated by reference herein in its entirety.

### II. FIELD

The present disclosure is generally related to processors, and more specifically related to thread priority and interrupt steering.

### III. DESCRIPTION OF RELATED ART

Advances in technology have resulted in more powerful computing devices. For example, computing devices such as laptop and desktop computers and servers, as well as wireless computing devices such as portable wireless telephones, have improved computing capabilities and are able to perform increasingly complex operations. Increased computing capabilities have also enhanced device capabilities in various other applications. For example, vehicles may include processing devices to enable global positioning system operations or other location operations, self-driving operations, interactive communication and entertainment operations, etc. Other examples include household appliances, security cameras, metering equipment, etc., that also incorporate computing devices to enable enhanced functionality, such as communication between internet-of-things (IoT) devices.

A computing device may include one or more digital signal processors (DSPs), image processors, or other processing devices that may use a real-time operating system (RTOS) having strict priority scheduling. Typically, in a multithreaded system, a RTOS maintains interrupt masks in software to steer interrupts to the thread running the lowest priority task. However, maintaining an interrupt mask in software increases operating system overhead and latency for the interrupts.

Sometimes a lowest-priority thread performs an operation that should not be interrupted (an “uninterruptible” operation), such as reading from a memory or making an operating system (OS) call. However, when the software maintaining the thread priority values and the interrupt mask is unaware of the initiation and/or resolution of such uninterruptible operations, interrupts may continue to be directed to the low-priority thread while an uninterruptible operation is ongoing, resulting in high latency or other undesirable performance at the processor. Also, because the operating system must check to ensure the schedule is correct, e.g., that all running tasks have higher priority than all waiting-to-execute tasks, an inaccuracy in the priority of the threads may cause scheduling errors in which higher-priority tasks wait while lower-priority tasks are executed.

### IV. SUMMARY

In a particular aspect, a processor includes multiple threads configured to execute tasks. The processor includes priority adjustment circuitry configured to adjust a priority of a thread of multiple threads configured to execute tasks, the priority adjustment circuitry configured to adjust the priority to have a software-defined priority value or a designated high priority value. The processor also includes a lowest priority thread detector configured to identify a lowest priority thread of the multiple threads and a control unit configured to cause the lowest priority thread to take a pending interrupt.

In another aspect, a method of operating a processor includes adjusting a priority of a thread of multiple threads to have a software-defined priority value or a designated high priority value. The method also includes identifying a lowest priority thread of the multiple threads and causing the lowest priority thread to take a pending interrupt.

In another aspect, an apparatus includes means for adjusting a priority of a thread of multiple threads to have a software-defined priority value or a designated high priority value. The apparatus also includes means for identifying a lowest priority thread of the multiple threads. The apparatus further includes means for causing the lowest priority thread to take a pending interrupt.

One particular advantage provided by at least one of the disclosed aspects is the ability to adjust the effective priority of executing threads responsive to one or more of the threads initiating or completing an “uninterruptible” operation. Hardware-based priority comparison circuitry enables accurate identification of the thread having the lowest effective priority to take an interrupt and also enables accurate rescheduling so that higher-priority tasks waiting to execute are assigned to threads executing tasks having lower effective priority. As a result, latency is reduced and performance is improved as compared to a processor that interrupts such “uninterruptible” operations, and scheduling errors may be avoided. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular implementation of a processor that includes circuitry to identify a lowest-priority executing thread.

FIG. 2 is a diagram illustrating a lowest priority thread detector circuit in accordance with a particular aspect of the processor of FIG. 1.

FIG. 3 is a diagram illustrating a reschedule interrupt circuit in accordance with a particular aspect of the processor of FIG. 1.

FIG. 4 is a flow chart of a particular implementation of a method of operation that may be performed by the processor of FIG. 1.

FIG. 5 is a block diagram of portable device that includes the processor of FIG. 1.

### VI. DETAILED DESCRIPTION

Particular aspects of the present disclosure are described below with reference to the drawings. In the description, common features are designated by common reference numbers. Further, it is to be appreciated that certain ordinal terms (e.g., “first” or “second”) may be provided for ease of reference and do not necessarily imply physical characteristics or ordering. Therefore, as used herein, an ordinal term (e.g., “first,” “second,” “third,” etc.) used to modify an element, such as a structure, a component, an operation, etc., does not necessarily indicate priority or order of the element with respect to another element, but rather distinguishes the element from another element having a same name (but for use of the ordinal term). In addition, as used herein, indefinite articles (“a” and “an”) may indicate “one or more” rather than “one.” Further, an operation performed “based on” a condition or event may also be performed based on one or more other conditions or events not explicitly recited.

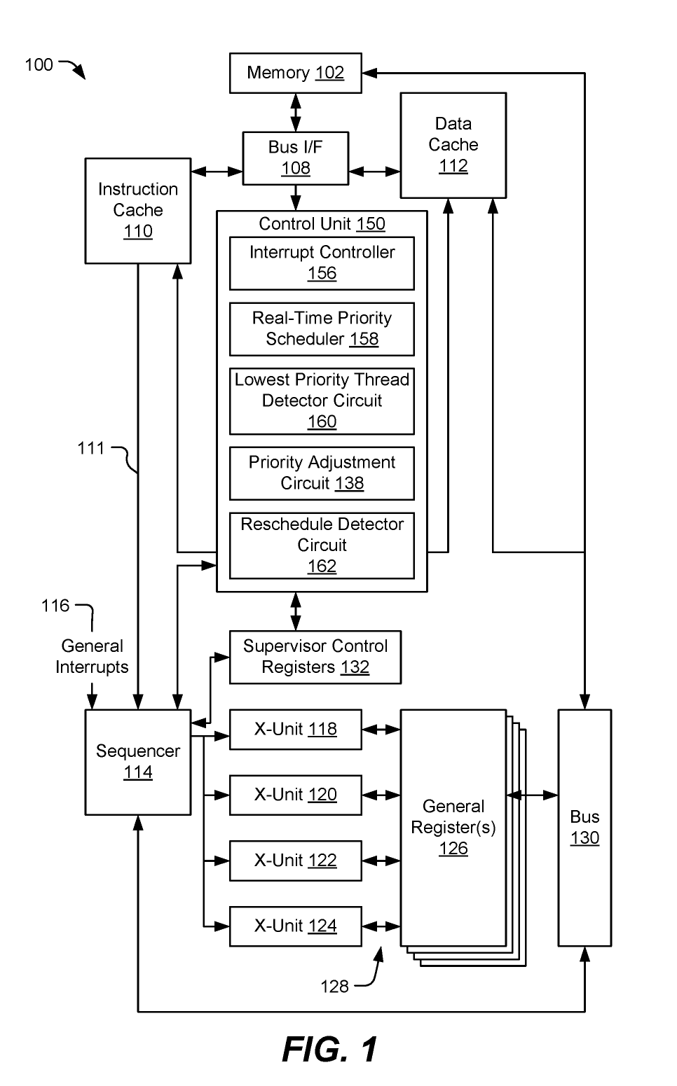

FIG. 1 depicts a multithreaded processor 100 that includes a memory 102 that is coupled to an instruction cache 110 via a bus interface 108. The multithreaded processor 100 also includes a data cache 112 that is coupled to the memory 102 via the bus interface 108. The instruction cache 110 is coupled to a sequencer 114 via a bus 111. The sequencer 114 can receive general interrupts 116, which may be retrieved from an interrupt register (not shown). The instruction cache 110 may be coupled to the sequencer 114 via a plurality of current instruction registers, which may be coupled to the bus 111 and associated with particular threads of the multithreaded processor 100. In a particular implementation, the multithreaded processor 100 is an interleaved multithreaded processor including multiple threads.

The bus 111 is coupled to instruction execution units 118, 120, 122, 124 that are coupled to a general register file 126 via a second bus 128. The general register file 126 is coupled via a third bus 130 to the sequencer 114, the data cache 112, and the memory 102.

The multithreaded processor 100 includes supervisor control registers 132 to store one or more priority settings that may be accessed by a control unit 150. Each processing thread may have one or more associated priority settings, such as one or more bit values stored at a supervisor status register that is dedicated to the particular thread. In an illustrative implementation of the processor 100 that supports four threads, the supervisor control registers 132 include four supervisor status registers that each include data fields to store a software-defined priority value, an effective priority value, and an “interruptible” indicator for the thread corresponding to that register.

The control unit 150 is configured to determine what tasks to execute on each of the processing threads and to steer interrupts to the processing thread executing the task having the lowest effective priority (e.g., the “worst” priority thread). The control unit 150 includes hardware configured to automatically raise a rescheduling interrupt if a task's effective priority is lower than the highest priority waiting-to-execute task. The rescheduling interrupt is processed (“taken”) by the worst priority thread and causes the worst priority thread to switch its current lower-priority task with a higher-priority waiting task.

The control unit 150 includes an interrupt controller 156, a real-time priority scheduler 158, a lowest priority thread detector circuit 160, a priority adjustment circuit 138, and a reschedule detector circuit 162. The real-time priority scheduler 158 is configured to determine what tasks to execute on each of the processing threads. In a particular example, the real-time priority scheduler 158 switches the best waiting task (that is waiting to execute and that has the highest priority of the waiting tasks) with the task that is executing on the worst priority thread.

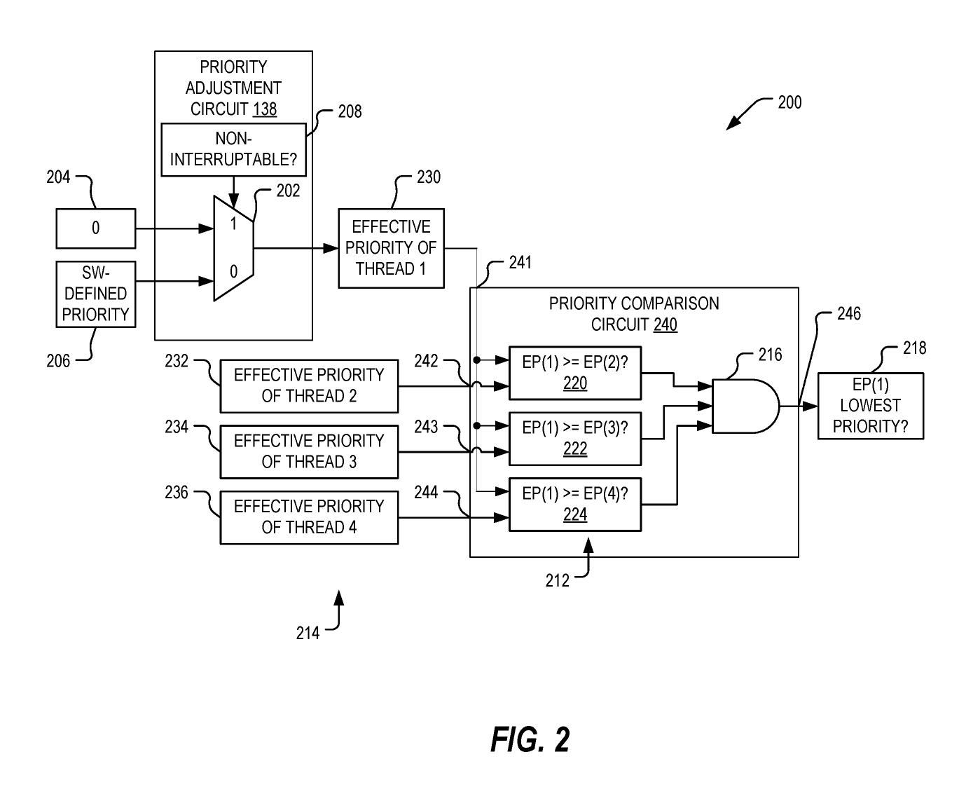

The lowest priority thread detector circuit 160 is configured to determine, based on priorities of threads executing at the processor 100, a thread having a lowest priority and to output an indication of the thread having the lowest priority to the real-time priority scheduler 158 so that interrupts can be taken by the thread determined to have the lowest priority. The lowest priority thread detector circuit 160 includes circuitry to perform comparisons of the priority of each thread to the priorities of other threads to determine which thread has a lowest priority, such as depicted in FIG. 2.

The priority adjustment circuit 138 is configured to perform a “situation-aware” priority determination that includes increasing a thread's effective priority in response to commencement of an uninterruptible operation and decreasing the thread's effective priority in response to termination of the uninterruptible operation. Increasing effective priority of a thread performing an uninterruptible operation so that the effective priority of the thread is higher than the effective priority of another executing thread causes interrupts to be taken by the other executing thread, preventing interruption of the uninterruptible operation.

The priority adjustment circuit 138, the lowest priority thread detector circuit 160, and the real-time priority scheduler 158 enable hardware steering of interrupts via hardware-based detection and selection of the worst priority thread. By performing priority comparisons in hardware rather than software, speed and accuracy of determining priority, including “situation-aware” priority determination that includes increasing effective priority in response to commencement of an uninterruptible operation and decreasing effective priority in response to termination of an uninterruptible operation, is improved and latency is reduced in the control unit 150.

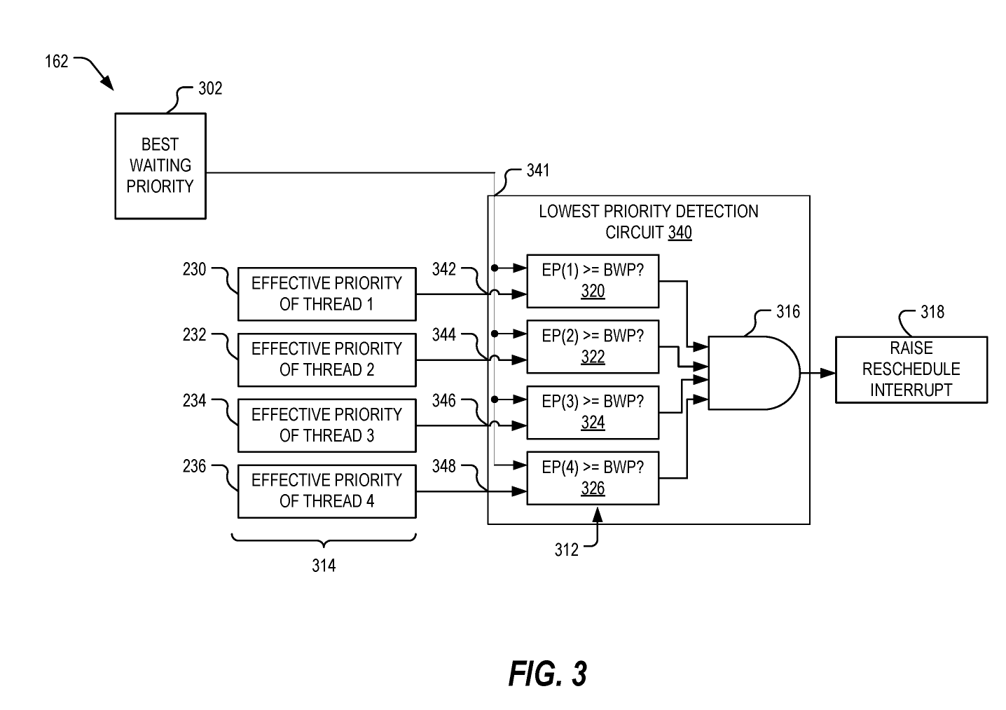

The reschedule detector circuit 162 is configured to determine whether a schedule generated by the real-time priority scheduler 158 is to be updated. For example, in response to detecting that the worst priority thread of the threads executing at the processor 100 has a worse priority than a ready task that is waiting for execution, the reschedule detector circuit 162 causes a rescheduling interrupt to be generated (“raised”), as described further with reference to FIG. 3. Because the reschedule detector circuit 162 uses one or more hardware components to perform comparisons and to generate a result, rescheduling speed and accuracy are improved as compared to a software implementation.

During operation, each thread executed by the processor 100 has a software-defined priority value that is recorded in a supervisor status register dedicated to that thread. To illustrate, each task to be executed by the processor 100 may have an associated software-defined priority value, and the software-defined priority value of the task may be used as the software-defined priority value of a thread that executes the task. The priority adjustment circuit 138 determines an effective priority value of each of the threads as either the software-defined priority value of the thread, if the thread is not performing an uninterruptible task, or as a designated high priority value, if the thread is performing an uninterruptible task. When an interrupt is raised, the lowest priority thread detector circuit 160 compares the effective priority of each of the threads to identify the thread having the lowest effective priority. The interrupt controller 156 receives an indication of the thread identified as having the lowest effective priority and steers the interrupt to the identified thread. If two or more threads have the same lowest effective priority (e.g., when all threads are executing uninterruptible tasks), a lowest-priority thread is selected to take the interrupt based on another criterion, such as a “round robin”-type selection or according to a determined thread order, as non-limiting examples.

In response to one of the threads initiating an uninterruptible task or finishing an uninterruptible task, the priority adjustment circuit 138 updates the effective priority of the thread. In an example, the sequencer 114 or an execution unit 118, 120, 122, or 124 updates the “interruptible” indicator in the supervisor status register for the thread upon initiating (or completing execution of) an operating system call or a device memory access for the thread. The priority adjustment circuit 138 updates the effective priority of the thread responsive to the updated the “interruptible” indicator in the supervisor status register for the thread, such as described in further detail with reference to FIG. 2.

When one or more tasks are waiting for execution, the reschedule detector circuit 162 compares the best ready task priority to the lowest effective priority thread. In response to determining that the best ready task has higher priority than the lowest effective priority thread, the reschedule detector 162 raises a rescheduling interrupt and resets the best ready task priority to indicate a low priority after the rescheduling interrupt is raised. After the reschedule interrupt is raised, the register holding the best ready thread priority may be reset by the hardware to prevent additional spurious reschedule interrupts. The interrupt controller 156 steers the rescheduling interrupt to the thread identified by the lowest priority thread detector circuit 160, and the rescheduling interrupt causes the identified thread to switch tasks with the best ready task that is waiting for execution. After switching tasks, one or more rescheduling interrupts may be raised and serviced in response to detection of another best ready task having higher priority than the worst priority thread.

Thus, the control unit 150 provides hardware steering of interrupts for the multithreaded processor 100. As opposed to a software-only implementation, the hardware implementation of FIG. 1 enables microarchitecture situation-aware priority determination, interrupt steering, and rescheduling interrupt generation that avoids interrupting uninterruptible tasks and that accommodates temporary priority changes of threads.

FIG. 2 depicts an example of a circuit 200 that includes a particular implementation of the priority adjustment circuit 138 and a priority comparison circuit 240 that may be included in the lowest priority thread detector circuit 160. The circuit 200 is depicted as an example configuration of priority evaluation circuitry of a first thread (“thread 1”) in a four-thread implementation of the processor 100.

The priority adjustment circuit 138 includes a multiplexor 202 configured to receive a first input that indicates a highest possible thread priority value 204 (e.g., a “0” value). The multiplexor 202 is further configured to receive a second input that indicates a priority value 206 of the first thread. For example, the priority value 206 may be a software-programmed priority value for the first thread that is stored in the supervisor status register for the first thread. The multiplexor 202 also receives a control signal 208 (e.g., from the supervisor status register for the first thread) that indicates whether the first thread has an uninterruptible status. For example, one or more circumstances may occur at the processor 100 that cause the first thread to be uninterruptible. In response to the indicator 208 indicating that the first thread is uninterruptible, the multiplexor 202 selects the highest priority value 204 to output; otherwise, the multiplexor 202 outputs the software-defined priority value 206.

The output of the multiplexor 202 corresponds to a first effective priority value 230 of the first thread. In a particular implementation, the first effective priority value 230 corresponds to a number, such as a value in the range from 0 to 256, with 0 indicating the highest possible (e.g., “best”) priority and 256 indicating the lowest possible (e.g., “worst”) priority. The first effective priority value 230 may be stored into the supervisor status register for the first thread.

The priority comparison circuit 240 has a first input 241 that is coupled to receive the first effective priority value 230, a second input 242 that is coupled to receive a second effective priority value 232 of a second thread, a third input 243 that is coupled to receive a third effective priority value 234 of a third thread, and a fourth input 244 that is coupled to receive a fourth effective priority value 236 of a fourth thread. The first effective priority value 230 is provided to a group of comparators 212 that each includes a first input to receive the first effective priority value 230 of the first thread and a second input to receive an effective priority value of one of the other executing threads of the processor 100, illustrated as a group 214 of the effective priority values 232-236.

Each comparator of the group of comparators 212 is configured to generate an output indicating whether the first effective priority value 230 of the first thread is greater than (i.e., indicates worse priority than) or equal to the other thread's effective priority value, or is less than the other thread's effective priority value. To illustrate, a first comparator 220 compares the first effective priority value 230 to the second effective priority value 232, a second comparator 222 compares the first effective priority value 230 to the third effective priority value 234, and a third comparator 223 compares the first effective priority value 230 to the fourth effective priority value 236. In response to each of the comparators 212 indicating that the effective priority values 232, 234, 236 of each of the other threads has a lower effective priority value than the first effective priority value 230 of the first thread (signifying that the particular thread has a worst effective priority of the executing threads at the processor 100), each input to a logic circuit 216 (e.g., an AND circuit) has a logical HIGH value, causing the logic circuit 216 to generate a signal 218 (e.g., a logical HIGH value) at an output 246 of the priority comparison circuit 240 indicating that the effective priority (EP(1)) of the first thread is the worst effective priority of the executing threads. Otherwise, in response to one or more of the comparators 220, 222, 224 of the group of comparators 212 indicating that at least one other executing thread has worse effective priority than the first thread, the signal 218 (the worst priority indicator) is not generated and instead the logic circuit 216 outputs a logical LOW value.

The lowest priority thread detector circuit 160 may include multiple instances of the circuit 200, one for each thread, so that circuitry for each thread may determine that thread's effective priority and whether or not that thread has (or is tied for) the worst effective priority of the executing threads. The lowest priority thread detector circuit 160 may further include circuitry responsive to the output 246 of each priority comparison circuit 240 to select a thread (if multiple threads have worst priority) and to indicate the selected thread to the interrupt controller 156.

FIG. 3 depicts an example implementation of the reschedule detector circuit 162. In FIG. 3, an indicator 302 of a “best ready value” indicates the priority value of the best priority ready task of a group of ready tasks that are waiting for execution at the processor 100. The indicator 302 is provided to a lowest priority detection circuit 340 that is configured to receive the indicator 302 at a first input 341 and a set of effective priority values 314 at inputs 342, 344, 346, and 348, and to generate an output indicating whether any of the set of effective priority values 314 has worse priority than the best ready value.

The lowest priority detection circuit 340 includes a set of comparators 312 coupled to a logic circuit 316. Each comparator of the set of comparators 312 is configured to receive an effective priority value of the set of effective priority values 214, and an output of each of the comparators 312 is provided to the logic circuit 316. The set of comparators 312 includes a first comparator 320 configured to compare the indicator 302 to the first effective priority value 230, a second comparator 322 configured to compare the indicator 302 to the second effective priority value 232, a third comparator 324 configured to compare the indicator 302 to the third effective priority value 234. and a fourth comparator 326 configured to compare the indicator 302 to the fourth effective priority value 236.

The logic circuit 316 is configured to generate a signal indicating whether to raise a rescheduling interrupt. For example, in response to the best waiting priority 302 having a higher numerical value (e.g., a worse priority) than each of the set of effective priority values 314, the logic circuit 316 generates a first value (e.g., a logical HI value) indicating that a reschedule interrupt is not to be raised. Otherwise, the logic circuit 316 generates a second value (e.g., a logical LO value) indicating that a reschedule interrupt is to be raised, illustrated as an indication 318.

The circuitry depicted in the examples of FIG. 2 and FIG. 3 is responsive to processor register values and hardware signals to enable reduced latency priority determinations and comparisons as compared to other implementations in which such determinations are implemented in software. As a result, operation at the processor 100, such as a RTOS, may be performed with higher efficiency and reduced scheduling errors as compared to using software-based priority determinations.

Although FIG. 2 and FIG. 3 correspond to implementations in which the processor 100 supports four threads, in other implementations the processor 100 may support fewer than four threads or more than four threads. Although each of FIG. 2 and FIG. 3 depicts a particular example of circuitry configured to perform thread priority-related operations, in other implementations other circuit configurations may be used in place of, or in addition to, the illustrated examples.

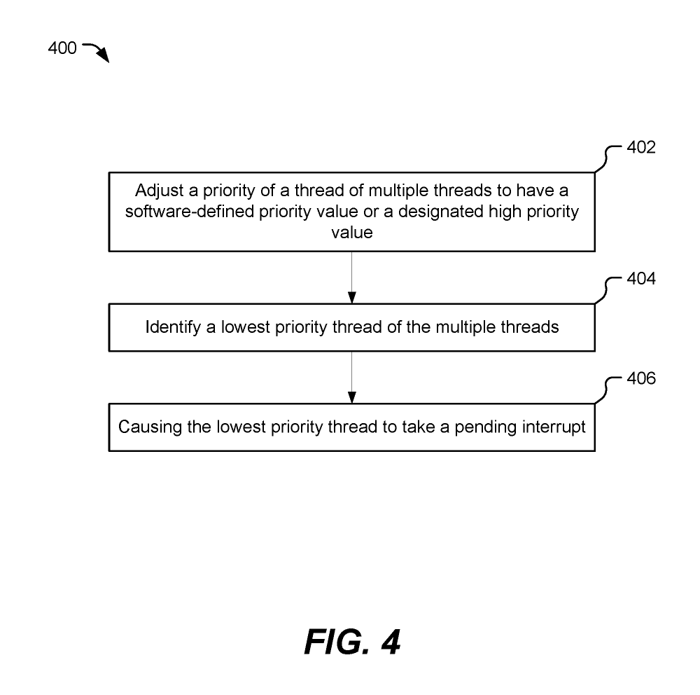

FIG. 4 depicts an example of a method 400 of operating a processor. For example, the method 400 may be performed by the processor 100 of FIG. 1. The method 400 includes adjusting a priority of a thread of multiple threads to have a software-defined priority value or a designated high priority value, at 402. The priority of each thread may be adjusted based on a microarchitectural state of the processor. As an illustrative example, adjusting the priority of the thread includes transitioning from the software-defined priority value to the designated high priority value in response to receiving an indication that the thread is interruptible. For example, the priority of the thread may be adjusted by the priority adjustment circuit 138 of FIG. 1, such as the multiplexor 202 of FIG. 2.

In a particular implementation, the priority of the thread is selected to be the designated high priority value in response to a device memory access or an operating system call associated with the thread. In an illustrative example, the priority of the thread is adjusted from the designated high priority value to the software-defined priority value in response to completion of the device memory access or the operating system call.

The method 400 includes identifying a lowest priority thread of the multiple threads, at 404. In an illustrative example, the lowest priority thread is identified by the lowest priority thread detector circuit 160, such as at the priority comparison circuit 240 of FIG. 2.

The method 400 includes causing the lowest priority thread to take a pending interrupt, at 406. For example, the interrupt controller 156 of FIG. 1 steers interrupts to the thread identified by the lowest priority thread detector circuit 160 as having the lowest effective priority.

The method 400 may also include performing thread rescheduling based on relative effective priorities of hardware threads and ready tasks that are waiting for execution. In an illustrative example, a best ready value of a highest priority task of a group of ready tasks is compared to the priority values of the multiple threads, and an interrupt is selectively raised based on the comparison. To illustrate, the priority values of the ready tasks in the group of ready tasks are compared to determine a highest priority ready task, and the best ready value corresponds to the priority value of the highest priority ready task. In a particular implementation, the interrupt is raised in response to the best ready value indicating a higher priority than any of the priority values of the multiple threads.

Adjusting thread priority to be a software-defined value or a designated high priority value enables the processor to perform situationally-aware interrupt steering to avoid interrupting a thread that may have a relatively low priority but that should not be interrupted. As a result, the processor steers interrupts to other threads to avoid interrupting threads performing processes such as device memory accesses or operating system calls. Processor efficiency may therefore be improved as compared to using static priority values without regard to microarchitectural state.

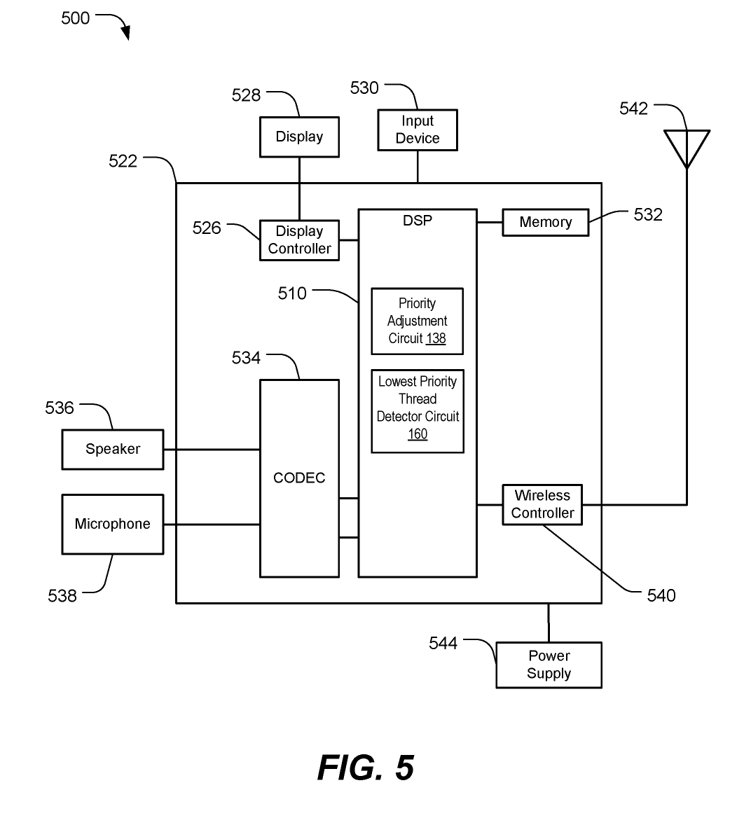

Referring to FIG. 5, a block diagram of a particular illustrative implementation of an electronic device including the processor 100 is depicted and generally designated 500. The electronic device 500 may correspond to a mobile device (e.g., a cellular telephone), as an illustrative example. In other implementations, the electronic device 500 may correspond to a computer (e.g., a server, a laptop computer, a tablet computer, or a desktop computer), a wearable electronic device (e.g., a personal camera, a head-mounted display, or a watch), a vehicle control system or console, a home appliance, a set top box, an entertainment unit, a navigation device, a television, a monitor, a tuner, a radio (e.g., a satellite radio), a music player (e.g., a digital music player or a portable music player), a video player (e.g., a digital video player, such as a digital video disc (DVD) player or a portable digital video player), a robot, a healthcare device, another electronic device, or a combination thereof.

The device 500 includes a processor 510, such as a digital signal processor (DSP), coupled to a memory 532. The processor 510 is configured to perform hardware-based, microarchitecture-aware thread priority determination and includes the priority adjustment circuit 138 and the lowest priority thread detector circuit 160 of FIG. 1. In an illustrative example, the processor 510 corresponds to the processor 100 of FIG. 1.

The memory 532 may be coupled to or integrated within the processor 510. The memory 532 may include random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), one or more registers, a hard disk, a removable disk, a compact disc read-only memory (CD-ROM), another storage device, or a combination thereof. The memory 532 stores one or more instructions that are executable by the processor 510 to perform operations, such as to cause one or more operations of the method 400 of FIG. 4 to be performed.

FIG. 5 also shows a display controller 526 that is coupled to the digital signal processor 510 and to a display 528. A coder/decoder (CODEC) 534 can also be coupled to the digital signal processor 510. A speaker 536 and a microphone 538 can be coupled to the CODEC 534.

FIG. 5 also indicates that a wireless controller 540 can be coupled to the processor 510 and to an antenna 542. In a particular implementation, the processor 510, the display controller 526, the memory 532, the CODEC 534, and the wireless controller 540, are included in a system-in-package or system-on-chip device 522. In a particular implementation, an input device 530 and a power supply 544 are coupled to the system-on-chip device 522. Moreover, in a particular implementation, as illustrated in FIG. 5, the display 528, the input device 530, the speaker 536, the microphone 538, the antenna 542, and the power supply 544 are external to the system-on-chip device 522. However, each of the display 528, the input device 530, the speaker 536, the microphone 538, the antenna 542, and the power supply 544 can be coupled to a component of the system-on-chip device 522, such as an interface or a controller.

The foregoing disclosed devices and functionalities, e.g., as described in reference to any one or more of FIGS. 1-5, may be designed and configured into computer files (e.g., RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. The chips are then employed in devices described above.

In connection with the disclosed examples, a non-transitory computer-readable medium (e.g., the memory 532) stores instructions that are executable by a processor (e.g., the processor 100 or the processor 510) to cause control circuitry to update a thread's effective priority and to identify a thread with a lowest effective priority to handle an interrupt. For example, in a particular aspect the memory 532 stores instructions, such as an instruction corresponding to a device memory access or an operating system call, to cause the processor 510 to perform the method 400 of FIG. 4.

In conjunction with the disclosed examples, an apparatus includes means for adjusting a priority of a thread of multiple threads to have a software-defined priority value or a designated high priority value. For example, the means for adjusting may correspond to the priority adjustment circuit 138 of FIG. 1, the multiplexor 202 of FIG. 2, one or more other circuits or devices to adjust a priority of a thread to have a software-defined priority value or a designated high priority value, or any combination thereof. The apparatus also includes means for identifying a lowest priority thread of the multiple threads. For example, the means for identifying may correspond to the lowest priority thread detector circuit 160 of FIG. 1, the priority comparison circuit 240 of FIG. 2, one or more other circuits or devices to identify a lowest priority thread, or any combination thereof. The apparatus also includes means for causing the lowest priority thread to take a pending interrupt, such as the interrupt controller 156 of FIG. 1.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Portions of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A processor comprising:
priority adjustment circuitry configured to adjust a priority of a thread of multiple threads configured to execute tasks, the priority adjustment circuitry configured to adjust the priority to have a software-defined priority value or a designated high priority value;
a lowest priority thread detector configured to identify a lowest priority thread of the multiple threads; and
a control unit configured to cause the lowest priority thread to take a pending interrupt.

2. The processor of claim 1, wherein the priority adjustment circuitry is configured to select the designated high priority value in response to an indication that the thread is uninterruptible.

3. The processor of claim 1, wherein the priority adjustment circuitry is configured to adjust the priority of the thread from the software-defined priority value to the designated high priority value in response to a device memory access associated with the thread or an operating system call associated with the thread.

4. The processor of claim 1, wherein the software-defined priority value of the lowest priority thread is based on a software-defined priority of a task executed by the lowest priority thread.

5. The processor of claim 1, further comprising:
reschedule detector circuitry configured to compare a best ready value of a highest priority task of a group of ready tasks to the priority values of the multiple threads and to raise an interrupt in response to the best ready value indicating a higher priority than any of the priority values of the multiple threads.

6. The processor of claim 5, wherein the best ready value is a software-programmed value.

7. The processor of claim 5, wherein the reschedule detector circuitry is further configured to reset the best ready value to indicate a low priority after the interrupt is raised.

8. A method of operating a processor, the method comprising:
adjust a priority of a thread of multiple threads to have a software-defined priority value or a designated high priority value;
identifying a lowest priority thread of the multiple threads; and
causing the lowest priority thread to take a pending interrupt.

9. The method of claim 8, wherein adjusting the priority of the thread includes transitioning from the software-defined priority value to the designated high priority value in response to an indication that the thread is interruptible.

10. The method of claim 8, wherein the priority of the thread is selected to be the designated high priority value in response to a device memory access or an operating system call associated with the thread.

11. The method of claim 10, further comprising adjusting the priority of the thread from the designated high priority value to the software-defined priority value in response to completion of the device memory access or the operating system call.

12. The method of claim 8, further comprising:
comparing a best ready value of a highest priority task of a group of ready tasks to the priority values of the multiple threads; and
selectively raising an interrupt based on the comparison.

13. The method of claim 12, wherein the interrupt is raised in response to the best ready value indicating a higher priority than any of the priority values of the multiple threads.

14. The method of claim 12, further comprising comparing priority values of the ready tasks in the group of ready tasks to determine a highest priority ready task, wherein the best ready value corresponds to the priority value of the highest priority ready task.

15. The method of claim 8, wherein causing the lowest priority thread to take a pending interrupt includes steering, by an interrupt controller, the pending interrupt to the thread that is identified as the lowest priority thread.

16. An apparatus comprising:
means for adjusting a priority of a thread of multiple threads to have a software-defined priority value or a designated high priority value;
means for identifying a lowest priority thread of the multiple threads; and
means for causing the lowest priority thread to take a pending interrupt.

17. The apparatus of claim 16, wherein the means for adjusting the priority of the thread is configured to transition from the software-defined priority value to the designated high priority value in response to an indication that the thread is interruptible.

18. The apparatus of claim 16, wherein the means for adjusting the priority of the thread is configured to selected to select the designated high priority value in response to a device memory access associated with the thread or an operating system call associated with the thread.

19. The apparatus of claim 18, wherein the means for adjusting the priority of the thread is configured to adjust the priority of the thread from the designated high priority value to the software-defined priority value in response to completion of the device memory access or the operating system call.

20. The apparatus of claim 16, further comprising:
means for comparing a best ready value of a highest priority task of a group of ready tasks to the priority values of the multiple threads; and
means for selectively raising an interrupt responsive to the means for comparing.
